(19) United States
(12) Patent Application Publication
(10) Pub. No.: US 2007/0299560 A1
(43) Pub. Date: Dec. 27, 2007

(54) Energy-saving control methodology for engine-off HVAC module used in over-the-road applications

(76) Inventors: Richard V. LaHue, Danville, KY (US); Carol S. Galloway, Lawrenceburg, KY (US); Kylie L. Levake, Lexington, KY (US); William W. Wang, Nicholasville, KY (US); Samuel J. Collier, Danville, KY (US); Jeffrey A. Logic, Racine, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 11/474,634

(22) Filed: Jun. 26, 2006

(51) Int. Cl. G05D 23/00

(52) U.S. Cl. 700/276; 165/42

(57) ABSTRACT

An energy saving HVAC system for a passenger compartment of an over the road vehicle comprises a controllable air conditioner system for directing cooled air flow through the passenger compartment. A controllable heater system directs heated air flow through the passenger compartment. A user control panel includes user input devices for manually selecting operating parameters of the HVAC system, one of the user input devices comprising an economy mode selector. A controller is operatively connected to the air conditioner system, the heater system and the user control panel. The controller normally controls the air conditioner system or the heater system in accordance with manually selected operating parameters and, responsive to a user manually selecting the economy mode, overrides the manually selected operating parameters and controls the air conditioner system or the heater system at a preselect energy saving level responsive to the economy mode being selected.

### CROSS REFERENCE TO RELATED APPLICATIONS

There are no related applications.

### FIELD OF THE INVENTION

The invention relates to vehicle HVAC systems, and in more particular to HVAC systems for the passenger compartments of large vehicles.

### BACKGROUND OF THE INVENTION

Currently, air conditioning systems for vehicles, and particularly for the passenger compartments of large trucks, is provided via an engine driven air conditioning system. However, concern over pollution, both air and noise, is creating the potential that trucks will no longer be allowed in some instances to idle their engines in order to operate the air conditioning for the passenger compartment. In addition to concerns over pollution, it has been estimated that the costs for overnight idling include $2,400 per year in fuel consumption and $250 per year in added maintenance. With respect to air pollution, it has been estimated that a single truck idling for one year produces 250 lbs. of CO, 615 lbs. of NOₓ, and 17 tons of CO₂.

More recently, modular HVAC systems for passenger compartments have been developed which are generally modular or self-contained. Some or all of the modular components are located in the passenger compartment. Electrical power for the HVAC system can be provided by the vehicle's electrical system. Energy saving with a passenger compartment HVAC system can be important, particularly when a vehicle engine is off and separate power sources are not available, requiring the HVAC module to run off battery power. Depending upon available battery power and time requirements for operation of the HVAC module, it can be important to limit and/or control the heating and air conditioning systems.

### SUMMARY OF THE INVENTION

The present invention is directed to energy savings in HVAC systems for a passenger compartment of an over the road vehicle.

There is disclosed in accordance with one aspect of the invention a method of operating a heating, ventilation, and air conditioning (HVAC) system for a passenger compartment of an over the road vehicle. The HVAC system includes a controllable air conditioner system and a controllable heater system for respectively directing cooled or heated air flow through the passenger compartment. The method comprises a user manually selecting operating parameters of the HVAC system; normally controlling the air conditioner system or the heater system in accordance with manually selected operating parameters; a user selectively commanding an economy mode of operation; and responsive to a user selectively commanding the economy mode overriding the manually selected operating parameters and controlling the air conditioner system or the heater system at a preselect energy saving level responsive to the economy mode being selected.

It is one feature of the invention that the heater system can be controlled to produce a plurality of heat output levels and wherein controlling the heater system at the preselect energy saving level responsive to the economy mode being selected comprises selecting a lowest of the plurality of heat output levels.

It is another feature of the invention that the heater system comprises a variable speed blower and wherein controlling the heater system at the preselect energy saving level responsive to the economy mode being selected comprises selecting a lowest blower speed.

It is still another feature of the invention that the air conditioner system comprises a variable speed compressor and wherein controlling the air conditioner system at the preselect energy saving level responsive to the economy mode being selected comprises selecting a lowest compressor speed.

It is still another feature of the invention that the air conditioner system comprises a compressor normally controlled at a single speed and wherein controlling the air conditioner system at the preselect energy saving level responsive to the economy mode being selected comprises operating the compressor intermittently.

It is yet another feature of the invention that the air conditioner system comprises a variable speed blower and wherein controlling the air conditioner system at the preselect energy level responsive to the economy mode being selected comprises selecting a lowest blower speed.

It is still a further feature of the invention to power the HVAC system from vehicle power sources if a vehicle engine is on or from a battery if the vehicle engine is off.

There is disclosed in accordance with another aspect of the invention a method of operating an HVAC system for a passenger compartment of an over the road vehicle. The HVAC system includes an air conditioner system including a variable cooling level output and a heater system including a variable heating level output, for respectively directing cooled or heated air flow through the passenger compartment. The HVAC system is selectively powered from vehicle power sources or from a battery. The method comprises providing a user control panel including user input devices for manually selecting operating parameters of the HVAC system, one of the user input devices comprising an economy mode selector; normally controlling the air conditioner system or the heater system in accordance with the manually selected operating parameters; and responsive to a user manually selecting the economy mode overriding the manually selected operating parameters and controlling the air conditioner system or the heater system at a preselect energy saving level responsive to the economy mode being selected.

There is disclosed in accordance with still another aspect of the invention an energy saving HVAC system for a passenger compartment of an over the road vehicle comprising a controllable air conditioner system for directing cooled air flow through the passenger compartment. A controllable heater system directs heated air flow through the passenger compartment. A user control panel includes user input devices for manually selecting operating parameters of the HVAC system, one of the user input devices comprising an economy mode selector. A controller is operatively connected to the air conditioner system, the heater system and the user control panel. The controller normally controls the air conditioner system or the heater system in accordance with manually selected operating parameters and, responsive to a user manually selecting the economy mode, overrides the manually selected operating parameters and controls the air conditioner system or the heater system at a preselect energy saving level responsive to the economy mode being selected.

Further features and advantages of the invention will be readily apparent from the specification and from the drawings.

### BRIEF DESCRIPTION OF THE DRAWINGS

FIG. 1 is a combined electrical schematic and block diagram for an energy saving HVAC system for a passenger compartment of an over the road vehicle in accordance with the invention;

FIG. 2 is a view of a sleeper compartment user control panel of the HVAC system of FIG. 1;

FIG. 2A is a view of a cab control user control panel of the HVAC system of FIG. 1; and

FIG. 3 is a flow diagram illustrating control logic implemented by the HVAC system of FIG. 1.

### DETAILED DESCRIPTION OF THE INVENTION

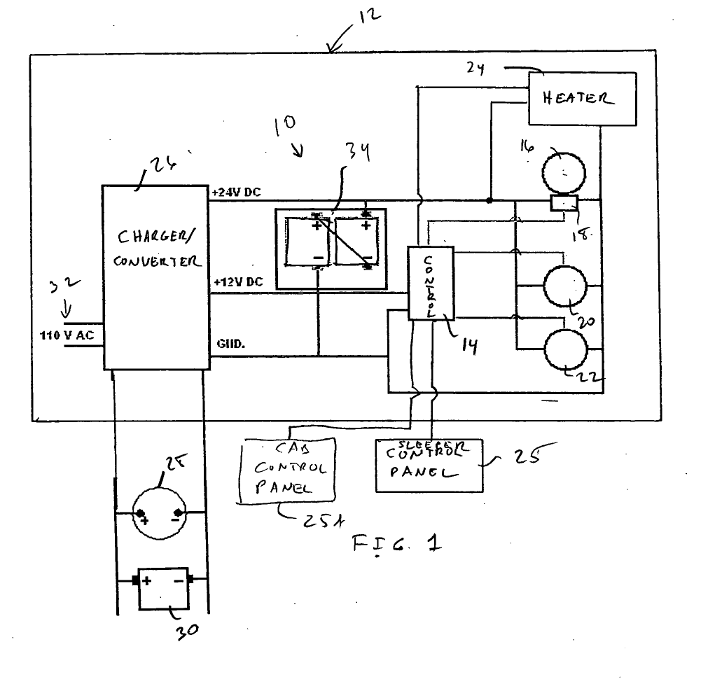

With reference to FIG. 1, the invention relates to a heating, ventilation and air conditioning (HVAC) module or system 10 that maintains comfortable temperatures in a passenger compartment of a vehicle, represented by the outline 12, without operating the main engine by utilizing an electronic control scheme in a controller 14 that efficiently matches the heating and/or cooling output to the heating and/or cooling requirements. The passenger compartment 12 may comprise a sleeper compartment and/or the cab or driver compartment.

This HVAC system 10 consists of selected HVAC components and sensors that can be controlled to deliver cooling capacity as required while minimizing the power consumed. Preferably, for air conditioning, the HVAC system 10 includes a compressor 16, a compressor controller 18, a condenser fan 20, and an evaporator blower 22, all of which are continuously variable speed. The HVAC system 10 further preferably includes additional components (not shown) such as a condenser, a pressure reduction device, such as an expansion valve, thermostatic expansion valve, orifice tube, and preferably an electronically controlled expansion valve, and an evaporator, all connected in series in a refrigerant flow path with the compressor 20. The air conditioning system components themselves may be conventional in nature. An exemplary such air conditioning system is shown and described in an application entitled “Energy Efficient Capacity Control System For An Air Conditioning System”, Ser. No. 11/130,576, filed May 17, 2005, the specification of which is hereby incorporated by reference herein. The evaporator blower 22 directs cooled air flow through the passenger compartment 12, as is conventional.

The HVAC system 10 also includes a heater 24. The heater 24 may be a conventional fuel fired heater or a resistance heater. A fuel fired heater operates off vehicle fuel and is operated to produce a plurality of heat output levels. Such a fuel fired heater includes a self-contained coolant pump which directs heated coolant in the path of the evaporator blower 22 through the sleeper compartment 12. If a resistance heater or the like is used, then the resistance heater can be placed in the air flow path of the evaporator blower 22, as is known. As is apparent, a separate blower could also be used.

The HVAC system 10 includes an operator interface provided by a user control panel 25 connected to the controller. The user control panel would typically be located in the sleeper compartment. The controller 14 is also electrically connected to and controls the compressor controller 18, the condenser fan 20, the evaporator blower 22, and the heater 24.

The HVAC system 10 includes a power system module in the form of a charger/converter 26 connected to a vehicle alternator 28 and vehicle battery 30 and selectively connected to a 110 volt AC power source 32 for use of shore power. The HVAC system 10 in an engine off conditions is powered by a battery 34 providing 24 volt DC power. Preferably, the charger/converter 26 converts 110 volt AC power to 24 volt DC for unit and auxiliary battery charging.

The HVAC system 10 may be mounted in one or more housings mounted in the passenger compartment 12. Some compounds may be mounted elsewhere. The present invention is not directed to the particular form of the HVAC system per se, but rather to the energy saving control methodology used in the HVAC system 10, as described below.

As seen in FIG. 1, the controller 14 operates off of 12 volt DC power, while the compressor 16, the condenser fan 20, the evaporator blower 22 and the heater 24 operate off of 24 volt DC power.

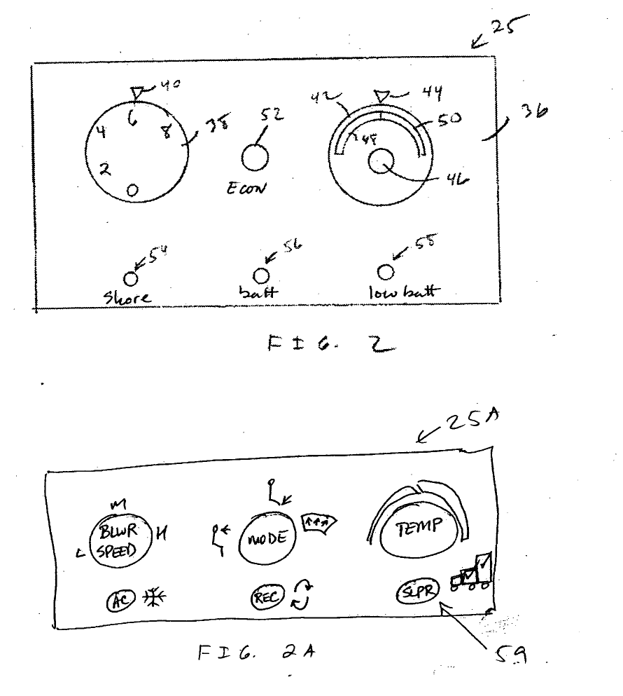

Referring to FIG. 2, the control panel 25 comprises a face plate 36. Mounted to the face plate 36 are a first rotary control knob 38, and associated level marker 40, and a second rotary control knob 42, and associated indicator marker 44. The second rotary control knob 42 also functions as a push button. The first rotary control knob 38 is used for blower speed in both heating and cooling modes and heat output level in heating mode, and includes indicia indicating numeric levels of blower speed. The desired level of blower speed is represented by the particular indicia proximate the marker 40.

The second rotary control knob 42 push button function is used to select the A/C, i.e., cooling mode. In the A/C mode, an indicator light 46 illuminates. The second rotary control knob 42 includes a cooling band 48 and a heating band 50. In the AC mode, the compressor speed is determined by the position of the cooling band 48 proximate the marker 44. In the heating mode, a water or air valve control level output is determined by the position of the heating band 50 relative to the marker 44.

The user control panel 25 includes an economy mode push button 52, which may be illuminated. The push button 52 allows a user to select an economy operating mode in accordance with the invention, as described below. Additionally, the control panel 25 includes an indicator light 54 for shore power, an indicator light 56 to show when battery power is used and an indicator light 58 used to indicate a low battery condition.

The knobs and push buttons are conventional in nature and are used to manually select operating parameters used by the controller 14 for controlling the compressor controller 18, the condenser fan 20, the evaporator blower 22, and the heater 24. The controller 14 may comprise a logic controller of any known form for controlling the various output devices.

In a normal operating mode, assuming the economy mode is not selected, then control operation is as follows. In an illustrative embodiment of the invention, the heater 24 provides either a low heat output or a high heat output and has four blower speeds. When the first rotary control knob 38 is set to 1, 2, 3 or 4, a low heat output is used and blower speed is determined by the numeric setting. When the first rotary control knob 38 is set to 5, 6, 7 or 8, then the fuel fired heater 24 is set to produce the higher heat output at one of the four blower speeds as determined by the numeric setting. In an air conditioning mode, the first rotary control knob 38 is used to control speed of the evaporator blower 22. The second rotary control knob 42 controls a water or air valve using the band 50 in the heating mode and compressor speed using the band 48 in the cooling mode.

Referring to FIG. 2A, a second control panel 25A for use in a cab is illustrated. The second control panel 25A is generally conventional in nature and is adapted to include a push button 59 for operating the HVAC system 10 from the cab. Particularly, when the button 59 is pressed, the cab controls can be used to control the HVAC module. Alternatively, the button 59 can be used to power the HVAC system 10.

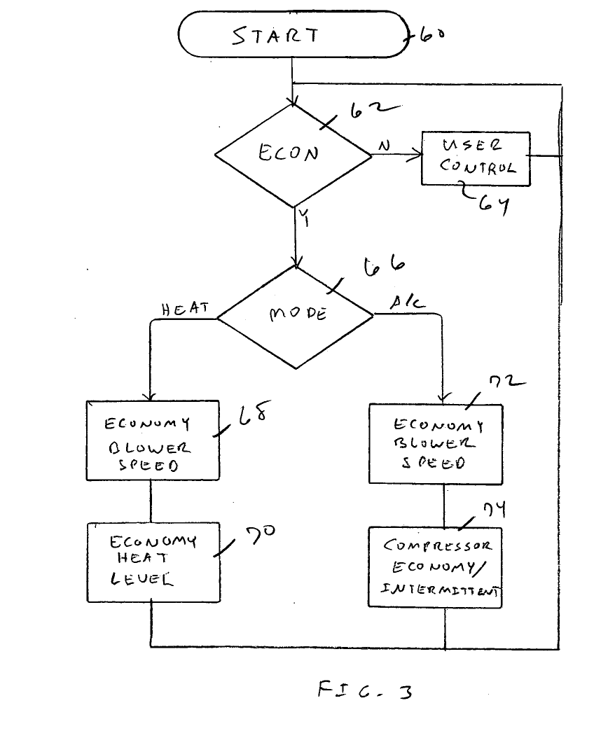

Referring to FIG. 3, a flow diagram illustrates logic implemented by the controller 14 beginning at a start mode 60. A decision block 62 determines if the controller is in an economy mode, as selected by using the push button 52, see FIG. 2, or by command from the cab control 25A. If not, then the controller operates in a normal mode under user control at a block 64. The user control scheme is discussed above in which the air conditioner system or the heater system are controlled in accordance with the manually selected operating parameters. The following describes parameters being controlled in the sleeper compartment 12 using the control panel 25 of FIG. 2. If the economy mode is selected, then a decision block 66 determines if the system 10 is operating in heat mode or in A/C mode, as determined by the push button function of the second rotary control knob 42. In the economy mode, the controller 14 overrides the manually selected operating parameters set by the knobs 38 and 42 and controls the air conditioner system or the heater system at a preselect energy saving level. For example, in the heat mode the heater 24 is set to the most energy saving blower speed at a block 68 and the heat output level is set to the most energy saving output level at a block 70. The controller then returns to the decision block 62. In the A/C mode, the blower 22 is set to the most energy saving blower speed at a block 72 and the compressor 16 is controlled to the most energy saving compressor speed at a block 74. The controller then loops back to the block 62. The most energy saving level is the level that consumes the lowest amount of energy and may be the lowest level, depending on the particular devices. Operation would be generally similar under control of the second control panel 25A.

In an alternative embodiment of the invention, the compressor 16 may be controlled at a single speed in the normal operating mode and operated intermittently at the block 74 during the economy mode.

The economy mode is advantageously used during engine off conditions to provide energy saving and preserve battery power. However, the economy mode is not limited to the engine OFF condition, but can be used at any time such as with an engine ON condition operating off alternator power or the like or operating off of shore power. The HVAC system 10 provides the ability for an over the road vehicle occupant to conserve energy, particularly while the vehicle engine is off.

As is apparent, the number of blower speeds, compressor speeds and water valve detents is variable. Also, the economy mode may be applied to a portable generator set that is mounted on the vehicle. Such a generator set could draw fuel from the fuel tank, heat the occupied space with waste heat from the generator, and power any electronics required to operate the HVAC system and associated controls. The economy mode for a generator set would correspond to the lowest energy using settings available on all required components to operate the HVAC system.

Although the energy used to charge the batteries 34 is intended to come from the vehicle's alternator 28, shore power 32 or a generator set, the energy could be derived from regenerative braking in the hybrid vehicle, a solar power from a photovoltaic cell, or even a hydrogen fuel cell. The concept of an economy mode button selected by the operator for over the road or parked operation can be used to save energy expended in thermally treating the occupied space, regardless of power source.

The present invention has been described with respect to flowcharts and block diagrams. It will be understood that each block of the flowchart and block diagrams can be implemented by computer program instructions. These program instructions may be provided to a processor to produce a machine, such that the instructions which execute on the processor create means for implementing the functions specified in the blocks. The computer program instructions may be executed by a processor to cause a series of operational steps to be performed by the processor to produce a computer implemented process such that the instructions which execute on the processor provide steps for implementing the functions specified in the blocks. Accordingly, the illustrations support combinations of means for performing a specified function and combinations of steps for performing the specified functions. It will also be understood that each block and combination of blocks can be implemented by special purpose hardware-based systems which perform the specified functions or steps, or combinations of special purpose hardware and computer instructions.

Thus, there is disclosed a system and method providing energy savings in HVAC systems for a passenger compartment of an over the road vehicle.

We claim:

1. A method of operating a heating, ventilation, and air conditioning (HVAC) system for a passenger compartment of an over the road vehicle, the HVAC system including a controllable air conditioner system and a controllable heater system for respectively directing cooled or heated air flow through the passenger compartment, the method comprising:
a user manually selecting operating parameters of the HVAC system;
normally controlling the air conditioner system or the heater system in accordance with manually selected operating parameters;
a user selectively commanding an economy mode of operation; and
responsive to a user selectively commanding the economy mode overriding the manually selected operating parameters and controlling the air conditioner system or the heater system at a preselect energy saving level responsive to the economy mode being selected.

2. The method of claim 1 wherein the heater system can be controlled to produce a plurality of heat output levels and wherein controlling the heater system at the preselect energy saving level responsive to the economy mode being selected comprises selecting the heat output level providing the greatest energy savings.

3. The method of claim 1 wherein the heater system comprises a variable speed blower and wherein controlling the heater system at the preselect energy saving level responsive to the economy mode being selected comprises selecting a blower speed providing the greatest energy savings.

4. The method of claim 1 wherein the air conditioner system comprises a variable speed compressor and wherein controlling the air conditioner system at the preselect energy saving level responsive to the economy mode being selected comprises selecting a compressor speed providing the greatest energy savings.

5. The method of claim 1 wherein the air conditioner system comprises a compressor normally controlled at a single speed and wherein controlling the air conditioner system at the preselect energy saving level responsive to the economy mode being selected comprises operating the compressor intermittently.

6. The method of claim 1 wherein the air conditioner system comprises a variable speed blower and wherein controlling the air conditioner system at the preselect energy saving level responsive to the economy mode being selected comprises selecting a blower speed providing the greatest energy savings.

7. The method of claim 1 further comprising powering the HVAC system from vehicle power sources if a vehicle engine is on or from a battery if the vehicle engine is off.

8. A method of operating a heating, ventilation, and air conditioning (HVAC) system for a passenger compartment of an over the road vehicle, the HVAC system including an air conditioner system including a variable cooling level output, a heater system including a variable heating level output, for respectively directing cooled or heated air flow through the passenger compartment, the HVAC system being selectively powered from vehicle power sources or from a battery, the method comprising:
providing a user control panel including user input devices for manually selecting operating parameters of the HVAC system, one of the user input devices comprising an economy mode selector;
normally controlling the air conditioner system or the heater system in accordance with manually selected operating parameters; and
responsive to a user manually selecting the economy mode overriding the manually selected operating parameters and controlling the air conditioner system or the heater system at a preselect energy saving level responsive to the economy mode being selected.

9. The method of claim 8 wherein the controlling the heater system at the preselect energy saving level responsive to the economy mode being selected comprises selecting a lowest energy consuming level of the plurality of heat level output levels.

10. The method of claim 8 wherein the heater system comprises a variable speed blower and wherein controlling the heater system at the preselect energy saving level responsive to the economy mode being selected comprises selecting a lowest energy consuming blower speed.

11. The method of claim 8 wherein the air conditioner system comprises a variable speed compressor and wherein controlling the air conditioner system at the preselect energy saving level responsive to the economy mode being selected comprises selecting a lowest energy consuming compressor speed.

12. The method of claim 1 wherein the air conditioner system comprises a compressor normally controlled at a single speed and wherein controlling the air conditioner system at the preselect energy saving level responsive to the economy mode being selected comprises operating the compressor intermittently.

13. The method of claim 1 wherein the air conditioner system comprises a variable speed blower and wherein controlling the air conditioner system at the preselect energy saving level responsive to the economy mode being selected comprises selecting a lowest energy consuming blower speed.

14. An energy saving heating, ventilation, and air conditioning (HVAC) system for a passenger compartment of an over the road vehicle, comprising:
a controllable air conditioner system for directing cooled air flow through the passenger compartment;
a controllable heater system for directing heated air flow through the passenger compartment;
a user control panel including user input devices for manually selecting operating parameters of the HVAC system, one of the user input devices comprising an economy mode selector; and
a controller operatively connected to the air conditioner system, the heater system and the user control panel, the controller normally controlling the air conditioner system or the heater system in accordance with manually selected operating parameters, and, responsive to a user manually selecting the economy mode, overriding the manually selected operating parameters and controlling the air conditioner system or the heater system at a preselect energy saving level responsive to the economy mode being selected.

15. The energy saving HVAC system of claim 14 wherein in the economy mode the controller controls the heater system at a lowest energy consuming level of the plurality of heat level output levels.

16. The energy saving HVAC system of claim 14 wherein the heater system comprises a variable speed blower and in the economy mode the controller selects a lowest energy consuming blower speed.

17. The energy saving HVAC system of claim 14 wherein the air conditioner system comprises a variable speed compressor and in the economy mode the controller selects a lowest energy consuming compressor speed.

18. The energy saving HVAC system of claim 14 wherein the air conditioner system comprises a compressor and wherein in the economy mode the controller operates the compressor intermittently.

19. The energy saving HVAC system of claim 14 wherein the air conditioner system comprises a variable speed blower and in the economy mode the controller selects a lowest energy consuming blower speed.

20. The energy saving HVAC system of claim 14 further comprising a battery and the HVAC system is powered from vehicle power sources if a vehicle engine is on or from the battery if the vehicle engine is off.
